(19) United States
(12) Patent Application Publication
(10) Pub. No.: US 2023/0416572 A1
(43) Pub. Date: Dec. 28, 2023

(54) HIGH TEMPERATURE STABLE OPTICALLY TRANSPARENT PRESSURE SENSITIVE ADHESIVES

(71) Applicant: 3M INNOVATIVE PROPERTIES COMPANY, St. Paul, MN (US)

(72) Inventors: Jong-seob Won, Gyeonggi-do (KR); Kyung Hwan Yoon, Gyeonggi (KR)

(21) Appl. No.: 18/035,981

(22) PCT Filed: Nov. 9, 2021
(86) PCT No.: PCT/IB2021/060370

§ 371 Date: May 9, 2023

Related U.S. Application Data
(60) Provisional application No. 63/114,154, filed on Nov. 16, 2020.

(51) Int. Cl. C09J 7/38; C09J 133/08; C09J 11/06; C09J 11/04

(52) U.S. Cl. CPC C09J 7/385; C09J 133/08; C09J 2301/302; C09J 11/04; C09J 2301/408; C09J 11/06

(57) ABSTRACT

High temperature stable optically transparent pressure sensitive adhesives include a (meth)acrylate polymeric or copolymeric matrix and at least one high temperature stabilization agent. The (meth)acrylate polymeric or copolymeric matrix is the reaction product of at least one (meth)acrylate monomer having at least one hydroxyl group. The pressure sensitive adhesive composition, upon exposure to a temperature of at least 85° C. for 7 days, has an increase of cohesive strength as measured by stress relaxation of 0.1 or less.

### BACKGROUND

Adhesives have been used for a variety of marking, holding, protecting, sealing and masking purposes. Adhesive tapes generally comprise a backing, or substrate, and an adhesive. One type of adhesive, a pressure sensitive adhesive, is particularly preferred for many applications.

Pressure sensitive adhesives are well known to one of ordinary skill in the art to possess certain properties at room temperature including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as pressure sensitive adhesives are polymers designed and formulated to exhibit the requisite viscoelastic properties resulting in a desired balance of tack, peel adhesion, and shear strength. The most commonly used polymers for preparation of pressure sensitive adhesives are natural rubber, synthetic rubbers (e.g., styrene/butadiene copolymers (SBR) and styrene/isoprene/styrene (SIS) block copolymers), various (meth)acrylate (e.g., acrylate and methacrylate) copolymers and silicones. Each of these classes of materials has advantages and disadvantages.

### SUMMARY

Disclosed herein are high temperature stable optically transparent pressure sensitive adhesives. In some embodiments, the pressure sensitive adhesive composition comprises a (meth)acrylate polymeric or copolymeric matrix and at least one high temperature stabilization agent. The (meth)acrylate polymeric or copolymeric matrix comprises the reaction product of at least one (meth)acrylate monomer comprising at least one hydroxyl group. The pressure sensitive adhesive composition is optically transparent and upon exposure to a temperature of at least 85° C. for 7 days, the increase of cohesive strength as measured by stress relaxation is 0.1 or less.

Also disclosed are adhesive articles that comprise at least one substrate with a pressure sensitive layer as described above disposed on the substrate.

### DETAILED DESCRIPTION

Adhesives have been used for a variety of marking, holding, protecting, sealing and masking purposes. One type of adhesive, a pressure-sensitive adhesive, is particularly useful for many applications. The use of adhesives, especially pressure-sensitive adhesives, in areas such as the medical, electronic and optical industries is increasing. The requirements of these industries place additional demands upon the pressure-sensitive adhesive beyond the traditional properties of tack, peel adhesion and shear strength. New classes of materials are desirable to meet the increasingly demanding performance requirements for pressure-sensitive adhesives. Among the additional demands being placed upon pressure sensitive adhesives are optical properties, such as transparency, as well as high flexibility. Retention of these properties over the lifetime of the articles as well as through a range of aging conditions, such as elevated temperature aging is also becoming increasing important.

Among the classes of pressure sensitive adhesives that have found wide application in optical applications are (meth)acrylate-based pressure sensitive adhesives. These adhesives comprise a polymeric or copolymeric matrix that includes at least one (meth)acrylate monomer and may contain additional (meth)acrylate monomers as well as additional ethylenically unsaturated monomers. Frequently, acid monomers such as acrylic acid or methacrylic acid are incorporated into the (meth)acrylate-based matrix to improve the cohesive strength of the matrix. Some optical articles include acid-sensitive layers that may contact the adhesive layer, therefore acid-free (meth)acrylate pressure sensitive adhesives have been developed.

It has been observed that (meth)acrylate-based pressure sensitive adhesives, upon exposure to elevated temperatures develop an increase in cohesive strength. It is believed that this results from the formation of crosslinks between polymers in the (meth)acrylate composition. This crosslinking can be effected by the reaction of carboxylic acid groups on one polymer with an alcohol on another polymer (the Fischer esterification reaction shown below) or by a transesterification-type reaction (shown below).

R^{p1}—C(O)—OH+R^{p2}—C(O)—R′—OH→R^{p1}—C(O)—O—R′—C(O)—R^{p2}+H₂O Fischer Esterification

In this exemplary reaction C(O) is a carbonyl group —C═O, and the groups R^{p1} and R^{p2} refer to (meth)acrylate polymer chains and R′ is an alkylene group. It is clear to see from this reaction that an acid group on one polymer chain can react with a hydroxyl group on another polymer chain to form a crosslink between polymer chains.

R^{p1}—C(O)—O—R^{a}+R^{p2}—C(O)—R′—OH→R^{p1}—C(O)—O—R′—C(O)—R^{p2}+R^{a}—OH Transesterification Reaction

In this exemplary reaction C(O) is a carbonyl group —C═O, and the groups R^{p1} and R^{p2} refer to (meth)acrylate polymer chains, R′ is an alkylene group, and R^{a} is an alkyl group that may or may not be hydroxyl-functional. It is clear to see from this reaction that a hydroxyl group on one polymer chain can attack the ester linkage of another polymer chain to form a crosslink between polymer chains.

These crosslinking reactions increase the cohesive strength of the pressure sensitive adhesive. In many applications, this increase in cohesive strength is not necessarily a problem, but in applications where it is desirable that the pressure sensitive adhesive layer have high flexibility, the increased cohesive strength can be a major issue. If it is desired or required that the pressure sensitive adhesive remain flexible so that the article that contains the adhesive layer that is bendable, foldable, or rollable, these crosslinking reactions are undesirable.

One method for suppressing the Fischer esterification reaction is to add an acid scavenger to the polymeric composition to block the reaction of the acidic groups with alcohol groups. However, as was mentioned above, some acid-free (meth)acrylate adhesives have been developed. While these adhesives are not subject to the Fischer esterification reaction, they are still subject to the transesterification-type of crosslinking reaction. Thus, the addition of an acid scavenger to the pressure sensitive adhesive composition is not expected to affect the transesterification-type of crosslinking reaction.

It has been observed that upon exposure to elevated temperatures, (meth)acrylate pressure sensitive adhesives that contain hydroxyl groups but do not contain acid groups also increase in cohesive strength. As was mentioned above, adding a material that is acts as an acid scavenger is not expected to suppress the rise in cohesive strength in these pressure sensitive adhesives. Surprisingly, it has been found that the addition of a hydrotalcite or a carbodiimide suppresses the rise in cohesive strength in these pressure sensitive adhesives. Additionally, if acid groups are present in the pressure sensitive adhesive, the addition of hydrotalcite or a carbodiimide also suppresses the rise in cohesive strength in these compositions.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “adhesive” as used herein refers to polymeric compositions useful to adhere together two adherends. Examples of adhesives are pressure sensitive adhesives.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The term “(meth)acrylate” refers to monomeric acrylic or methacrylic esters of alcohols. Acrylate and methacrylate monomers or oligomers are referred to collectively herein as “(meth)acrylates”. Materials referred to as “(meth)acrylate-based” as used herein refer to polymers that contain at least a majority of (meth)acrylate units, but may also contain additional units derived from other ethylenically unsaturated groups.

The terms “room temperature” and “ambient temperature” are used interchangeably to mean temperatures in the range of 20° C. to 25° C.

The terms “Tg” and “glass transition temperature” are used interchangeably. If measured, Tg values are determined by Differential Scanning Calorimetry (DSC) at a scan rate of 10° C./minute, unless otherwise indicated. Typically, Tg values for copolymers are not measured but are calculated using the well-known Fox Equation, using the monomer Tg values provided by the monomer supplier, as is understood by one of skill in the art.

The term “adjacent” as used herein when referring to two layers means that the two layers are in proximity with one another with no intervening open space between them. They may be in direct contact with one another (e.g. laminated together) or there may be intervening layers.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The terms “free radically polymerizable” and “ethylenically unsaturated” are used interchangeably and refer to a reactive group which contains a carbon-carbon double bond which is able to be polymerized via a free radical polymerization mechanism.

Unless otherwise indicated, the terms “optically transparent”, and “visible light transmissive” are used interchangeably, and refer to an article, film or adhesive that has a high light transmittance over at least a portion of the visible light spectrum (about 400 to about 700 nm). Typically, optically transparent articles have a visible light transmittance of at least 90% and a haze of equal to or less than 10%.

Unless otherwise indicated, “optically clear” refers to an adhesive or article that has a high light transmittance over at least a portion of the visible light spectrum (about 400 to about 700 nm), and that exhibits low haze, typically less than about 5%, or even less than about 2%. In some embodiments, optically clear articles exhibit a haze of less than 1% at a thickness of 50 micrometers or even 0.5% at a thickness of 50 micrometers. Typically, optically clear articles have a visible light transmittance of at least 95%, often higher such as 97%, 98% or even 99% or higher.

Disclosed herein are pressure sensitive adhesive compositions that have improved high temperature stability. In some embodiments, the pressure sensitive adhesive composition comprises a (meth)acrylate polymeric or copolymeric matrix, and at least one high temperature stabilization agent. The (meth)acrylate polymeric or copolymeric matrix comprises the reaction product of at least one (meth)acrylate monomer comprising at least one hydroxyl group. The pressure sensitive adhesive composition is optically transparent and upon exposure to a temperature of at least 85° C. for 7 days, the increase of cohesive strength as measured by stress relaxation is 0.1 or less.

A wide range of polymeric or copolymeric matrices are suitable in the pressure sensitive adhesive compositions of this disclosure. The polymeric or copolymeric matrix is prepared by polymerizing a reaction mixture comprising at least (meth)acrylate monomer. The reaction mixture may further comprise additional monomers as described below, optional crosslinking agents as described below, and at least one initiator, typically a photoinitiator.

The polymeric or copolymeric matrix comprises at least one monomer that has hydroxyl functionality. In some embodiments, the polymeric or copolymeric matrix is the reaction product of a (meth)acrylate monomer of Formula 1:

H₂C═CR¹—(CO)—O—(CH₂)ₐ—OH

where R¹ is an H or a methyl group, (CO) is a carbonyl group C═O, and a is an integer from 1-5. Examples of suitable (meth)acrylate monomers of Formula 1 include HEA (hydroxyethyl acrylate), HEMA (hydroxyethyl methacrylate), hydroxypropyl acrylate, and HBA (hydroxybutyl acrylate).

In many embodiments, the polymeric or copolymeric matrix is a copolymeric matrix comprising a (meth)acrylate monomer of Formula 1 above, and at least one additional (meth)acrylate monomer of general Formula 2. Generally, the additional monomers comprise an alkyl (meth)acrylate, an aryl (meth)acrylate, or acrylic acid.

H₂C═CHR¹—(CO)—O—R² Formula 2

where R¹ is a hydrogen atom or a methyl group, (CO) is a carbonyl group C═O, and R² is a hydrogen atom, an alkyl group with 4-20 carbon atoms, or an aryl group. Typically, the additional monomer or monomers are alkyl (meth)acrylates and/or acrylic acid. As mentioned above, the alkyl group of the alkyl (meth)acrylate has an average of about 4 to about 20 carbon atoms, or an average of about 4 to about 14 carbon atoms. The alkyl group can optionally contain oxygen atoms in the chain thereby forming ethers or alkoxy ethers, for example. Examples of monomer A include, but are not limited to, 2-methylbutyl acrylate, isooctyl acrylate, lauryl acrylate, 4-methyl-2-pentyl acrylate, isoamyl acrylate, sec-butyl acrylate, n-butyl acrylate, n-hexyl acrylate, 2-ethylhexyl acrylate, n-octyl acrylate, n-decyl acrylate, isodecyl acrylate, isodecyl methacrylate, and isononyl acrylate. Other examples include, but are not limited to, poly-ethoxylated or -propoxylated methoxy (meth)acrylates such as acrylates of CARBOWAX (commercially available from Union Carbide) and NK ester AM90G (commercially available from Shin Nakamura Chemical, Ltd., Japan). Particularly suitable alkyl (meth)acrylates include isooctyl acrylate, 2-ethyl-hexyl acrylate, n-hexyl acrylate, and n-butyl acrylate. Combinations of various monomers can be used to make the copolymer.

Generally, the (meth)acrylate copolymer is formulated to have a resultant Tg of less than about 0° C. and more typically, less than about −10° C. Such (meth)acrylate copolymers generally include about 1 parts to about 40 parts per hundred of at least one monomer of Formula 1 and about 99 parts to about 60 parts per hundred of at least one monomer of Formula 2.

A crosslinking agent may be used to build the molecular weight and the strength of the (meth)acrylate copolymer. Generally, the crosslinking agent is one that is copolymerized with monomers of Formula 1 and Formula 2. Suitable crosslinking agents are disclosed in U.S. Pat. No. 4,737,559 (Kellen), U.S. Pat. No. 5,506,279 (Babu et al.), and U.S. Pat. No. 6,083,856 (Joseph et al.). The crosslinking agent can be a photocrosslinking agent, which, upon exposure to ultraviolet radiation (e. g., radiation having a wavelength of about 250 nanometers to about 400 nanometers), causes the copolymer to crosslink. An example of a suitable photocrosslinking agent is ABP (acrylbenzophenone).

The crosslinking agent is used in an effective amount, by which is meant an amount that is sufficient to cause crosslinking of the pressure sensitive adhesive to provide adequate cohesive strength to produce the desired final adhesion properties to the substrate of interest. Generally, the crosslinking agent is used in an amount of about 0.1 part to about 10 parts, based on the total amount of monomers.

One class of useful crosslinking agents include multifunctional (meth)acrylate species. Multifunctional (meth)acrylates include tri(meth)acrylates and di(meth)acrylates (that is, compounds comprising three or two (meth)acrylate groups). Typically, di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates.

Another useful class of crosslinking agents contain functionality which is reactive with carboxylic acid groups on the acrylic copolymer when a carboxylic acid group is present. Examples of such crosslinkers include multifunctional aziridine, isocyanate, epoxy, and carbodiimide compounds. Examples of aziridine-type crosslinkers include, for example 1,4-bis(ethyleneiminocarbonylamino)benzene, 4,4′-bis(ethyleneiminocarbonylamino)diphenylmethane, 1,8-bis(ethyleneiminocarbonylamino)octane, and 1,1′-(1,3-phenylene dicarbonyl)-bis-(2-methylaziridine). The aziridine crosslinker 1,1′-(1,3-phenylene dicarbonyl)-bis-(2-methylaziridine) (CAS No. 7652-64-4), commonly referred to as “Bisamide” is particularly useful. Common polyfunctional isocyanate crosslinkers include, for example, trimethylolpropane toluene diisocyanate, tolylene diisocyanate, and hexamethylene diisocyanate.

The reaction mixture also includes at least one initiator. Typically, the initiator or initiators comprise photoinitiators, meaning that the initiator is activated by light, typically ultraviolet (UV) light. Examples of suitable free radical photoinitiators include DAROCURE 4265, IRGACURE 184, IRGACURE 651, IRGACURE 1173, IRGACURE 819, LUCIRIN TPO, LUCIRIN TPO-L, commercially available from BASF, Charlotte, NC. Generally, the photoinitiator is used in amounts of 0.01 to 1 parts by weight relative to 100 parts by weight of total reactive components.

The polymeric or copolymeric matrix is prepared by preparing a reactive mixture with the monomer or mixture of monomers, optional crosslinking agent, and at least one initiator, typically a photoinitiator, and polymerizing the reactive mixture. The reactive composition components can be mixed by traditional methods known to those skilled in the art. Such methods include mixing, mechanical rolling, hot melt blending, etc.

The polymeric or copolymeric matrix can be prepared either by bulk polymerization methods or by a coating and curing process. In many embodiments, the method of preparing the pressure sensitive adhesive matrix comprises a coating and curing process. This process involves preparing a reactive mixture, partially curing the mixture to form a curable, coatable syrup, coating this syrup on a substrate to form a curable layer, covering the curable layer with a release liner, polymerizing the curable layer to form a cured layer. This method is described in, for example, U.S. Pat. No. 6,339,111 (Moon, et al.).

The pressure sensitive adhesive composition also comprises at least one high temperature stabilization agent. Typically, the high temperature stabilization agent is a material that is an acid scavenging agent. However, not all materials commonly used as acid scavenging agents are suitable. Among the classes of commonly used acid scavenging agents are epoxy compounds, tertiary amines, hydrotalcite, and carbodiimides. Suitable high temperature stabilization agents in the current disclosure are hydrotalcite, and carbodiimides.

Hydrotalcite is a layered double hydroxide of general formula Mg₆Al₂CO₃(OH)₁₆ 4(H₂O), whose name is derived from its resemblance with talc and its high water content.

A wide range of carbodiimides are suitable high temperature stabilization agents. Carbodiimides (IUPAC name methane diimine) are compounds with the general Formula 3:

R^{a}—N═C═N—R^{b} Formula 3.

The groups R^{a} and R^{b} may be the same or different and comprise a wide range of alkyl, substituted alkyl, aryl, or substituted aryl groups. Particularly suitable are carbodiimides where the groups R^{a} and R^{b} are substituted aryl groups. An example of a particularly suitable carbodiimide is bis(2,6-diisopropylphenyl) carbodiimide (structure below).

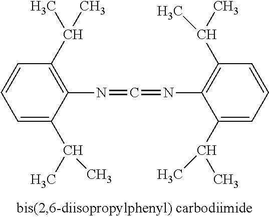 [SMILES: CC(C)c1cccc(C(C)C)c1N=C=Nc1c(C(C)C)cccc1C(C)C]

In some embodiments, the high temperature stabilization agent comprises a hydrotalcite. Because the hydrotalcite high temperature stabilization agent is an inorganic material, it is not soluble in the (meth)acrylate matrix and tends to form particles in the matrix. The presence of these particles of hydrotalcite increases the haze of the pressure sensitive adhesive. The pressure sensitive adhesive is optically transparent, having a visible light transmission of at least 90% and a haze of less than 10%.

In other embodiments, the high temperature stabilization agent comprises a carbodiimide. The carbodiimide is an organic material and is soluble in the (meth)acrylate matrix. The pressure sensitive adhesive is not only optically transparent, having a visible light transmission of at least 90% and a haze of less than 10%, but also is optically clear, having a visible light transmission of at least 95% and a haze of less than 5%. In some embodiments, the carbodiimide comprises bis(2,6-diisopropylphenyl) carbodiimide.

Whichever high temperature stabilization agent is used, it is present in small quantities. In some embodiments, the high temperature stabilization agent is present in the adhesive composition in an amount of 0.1-5% by weight. In some embodiments the high temperature stabilization agent is present in the adhesive composition in an amount of 0.5-3% by weight, or even 1-2% by weight.

Typically, the pressure sensitive adhesive composition is stable to a temperature of at least 85° C. for 7 days. In this context, stability refers to a suppression of an increase of cohesive strength of the pressure sensitive adhesive by increased crosslinking. Suppression of an increase of cohesive strength of the pressure sensitive adhesive can be measured in a variety of ways. One particularly suitable method is the measurement of increase of cohesive strength as measured by measuring the stress relaxation. In some embodiments, the pressure sensitive adhesives of this disclosure have an increase of stress relaxation is 0.1 or less after exposure to a temperature of at least 85° C. for 7 days. Stress relaxation can be measured with a rheometer. Stress relaxation is a measure of how much stress is released after applying a certain level of stress for a certain period of time. Stress relaxation is generally reported as a ratio of initial stress to final stress.

Also disclosed herein are adhesive articles. In some embodiments, the adhesive article comprises a substrate comprising a first major surface and a second major surface, and an adhesive layer disposed on at least a portion of the second major surface of the substrate. The adhesive layer comprises a pressure sensitive adhesive as described above. In some embodiments, the adhesive layer comprises a (meth)acrylate polymeric or copolymeric matrix, where the (meth)acrylate polymeric or copolymeric matrix comprises the reaction product of at least one (meth)acrylate monomer comprising at least one hydroxyl group, and at least one high temperature stabilization agent. The pressure sensitive adhesive composition is optically transparent and upon exposure to a temperature of at least 85° C. for 7 days, the increase of cohesive strength as measured by stress relaxation is 0.1 or less.

As described above, in many embodiments the (meth)acrylate is a copolymeric matrix comprising a copolymeric matrix that is the reaction product of a (meth)acrylate monomer of Formula 1 and at least one (meth)acrylate monomer of Formula 2, and optionally comprises a crosslinking agent.

As described above, in some embodiments the high temperature stabilization agent comprises hydrotalcite or a carbodiimide. The compositions that include hydrotalcite are optically transparent and the compositions that include carbodiimide are optically clear.

A wide range of substrates are suitable in the articles of this disclosure. Typically, the substrate comprises a polymeric film or a release liner. Examples of polymeric films include films comprising one or more polymers such as cellulose acetate butyrate; cellulose acetate propionate; cellulose triacetate; poly(meth)acrylates such as polymethyl methacrylate; polyesters such as polyethylene terephthalate, and polyethylene naphthalate; copolymers or blends based on naphthalene dicarboxylic acids; polyether sulfones; polyurethanes; polycarbonates; polyvinyl chloride; syndiotactic polystyrene; cyclic olefin copolymers; and polyolefins including polyethylene and polypropylene such as cast and biaxially oriented polypropylene. The substrate may comprise single or multiple layers, such as polyethylene-coated polyethylene terephthalate. The substrate may be primed or treated to impart some desired property to one or more of its surfaces. Examples of such treatments include corona, flame, plasma and chemical treatments.

One particularly suitable class of film substrates are optical films. As used herein, the term “optical film” refers to a film that can be used to produce an optical effect. The optical films are typically polymer-containing films that can be a single layer or multiple layers. The optical films can be of any suitable thickness. The optical films often are at least partially transmissive, reflective, antireflective, polarizing, optically clear, or diffusive with respect to some wavelengths of the electromagnetic spectrum (e.g., wavelengths in the visible ultraviolet, or infrared regions of the electromagnetic spectrum). Exemplary optical films include, but are not limited to, visible mirror films, color mirror films, solar reflective films, diffusive films, infrared reflective films, ultraviolet reflective films, reflective polarizer films such as brightness enhancement films and dual brightness enhancement films, absorptive polarizer films, optically clear films, tinted films, dyed films, privacy films such as light-collimating films, and antireflective films, antiglare films, soil resistant films, and anti-fingerprint films.

Some optical films have multiple layers such as multiple layers of polymer-containing materials (e.g., polymers with or without dyes) or multiple layers of metal-containing material and polymeric materials. Some optical films have alternating layers of polymeric material with different refractive indices. Other optical films have alternating polymeric layers and metal-containing layers. Exemplary optical films are described in the following patents: U.S. Pat. No. 6,049,419 (Wheatley et al.); U.S. Pat. No. 5,223,465 (Wheatley et al.); U.S. Pat. No. 5,882,774 (Jonza et al.); U.S. Pat. No. 6,049,419 (Wheatley et al.); U.S. Pat. No. RE 34,605 (Schrenk et al.); U.S. Pat. No. 5,579,162 (Bjornard et al.), and U.S. Pat. No. 5,360,659 (Arends et al.).

In some embodiments, the first carrier layer is a release liner. Exemplary release liners include those prepared from paper (e.g., Kraft paper) or polymeric material (e.g., polyolefins such as polyethylene or polypropylene, ethylene vinyl acetate, polyurethanes, polyesters such as polyethylene terephthalate, and the like, and combinations thereof). At least some release liners are coated with a layer of a release agent such as a silicone-containing material or a fluorocarbon-containing material. Exemplary release liners include, but are not limited to, liners commercially available from CP Film (Martinsville, Va.) under the trade designation “T-30” and “T-10” that have a silicone release coating on polyethylene terephthalate film.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wisconsin unless otherwise noted. The following abbreviations are used: sec=seconds; nm=nanometers; cm=centimeters; mW=milliWatts. The terms “weight %”, “% by weight”, and “wt %” are used interchangeably.

TABLE A
Adhesive Composition Components

| Abbreviation | Description and Supplier |
|---|---|
| HA | n-Hexyl acrylate, Bimax (US) |
| EHA | Ethylhexyl acrylate, LG Chem (KR) |
| EHMA | Ethylhexyl methacrylate, Mitzubish Gas. (JP) |
| AcM | Acrylamide, Zhejiang Xingyong (CN) |
| IBXA: | Isobornyl acrylate, Osaka Organic Chem (JP) |
| NNDMA | N,N-dimethylacrylamide, Kojin (JP) |
| DMAEA | Dimethylaminoethyl acrylate, Nippon Kasei (JP) |
| DMAPMA | 3-dimethylaminopropyl methacrylate, Aldrich (US) |
| AA | Acrylic acid, LG Chem. (KR) |
| HBA | 4-hydroxybutyl acrylate, Osaka Organic Chem. (JP) |
| HEA | 2-hyroxyethyl actylate, NSJ (JP) |
| Intiator-1 | Commercially available as DAROCUR 1173 (2- |
| | Hydroxy-2-methylpropiophenone), BAS F (US) |
| Intiator-2 | Commercially available as IRGACURE 184 (1-Hydroxy- |
| | cyclohexyl-phenyl-ketone), BASF (US) |
| Intiator-3 | Commercially available as IRGACURE 651 (2,2-Di- |
| | methoxy-2-phenylacetophenone), BASF (US) |
| HDDA | 1,6-Hexanedioldiacrylate, SK Cytec (KR) |
| Silane | Z6040: Glycidoxypropyltrimethoxy silane, Dow silicone |
| | (US) |
| UA | Urethane acrylate (Aliphatic urethane diacrylate), |
| | Commercially available as EBECRYL 230, Allnex (BG) |
| AO | Antioxidant, commercially available as IRGANOX |
| | 1010, BASF (US) |
| HALS-1 | Hindered amine light stabilizer, commercially available |
| | as TINUVIN 123, BASF (US) |
| HALS-2 | Hindered amine light stabilizer, commercially available |
| | as TINUVIN 765, BASF (US) |
| TEA | Triethyl amine |

### Test Methods

### Stress Relaxation:

Stress relaxation is defined as the amount of stress that is released when applying a specified level of stress for a specified period of time. Stress relaxation was reported as the ratio of storage modulus of the final stress/the initial stress, where initial is 0.1 sec, final is 300 sec, and the stress is 25% strain. The stress was applied to a sample with a 20 millimeter diameter and 500 micrometer thick adhesive (prepared by laminating together adhesive samples) at 70° C. using a DHR or ARES series rheometer from TA instruments. Initial stress and final stress values were recorded, and the stress relaxation ratio was calculated as the stress at 300 seconds/stress at 0.1 seconds. A higher stress relaxation number means higher cohesion or a more highly crosslinked adhesive.

### Haze Measurement

Haze was measured of adhesive/glass laminates using a BYK Hazegard spectrophotometer.

### Preparation of Adhesive Samples:

All the adhesive samples were prepared by UV pre-polymerization (0.6 mW/cm², min N₂ purge, Delta T 8° C.) and additive mixing to form a coatable syrup, followed by coating to a thickness of 50 micrometers onto a 75 micrometer-thick siliconized PET (polyethylene terephthalate) film, covering by another 75 micrometer-thick siliconized PET (polyethylene terephthalate) film, and cured with 1 to 10 mW of 365 nm UV radiation.

### Comparative Examples C1-C4

Adhesive samples were prepared as described above using the formulations shown in Table 1 below and tested for aging performance for various times and at various temperatures to demonstrate the issue with an increase in stress relaxation as evidence that crosslinking is occurring. Testing at 85° C. for 7 days for Comparative Examples C1-C4 is shown in Table 3.

TABLE 1
Comparative Adhesive Formulations

| Formulation | C1 | C2 | C3 | C4 |
|---|---|---|---|---|
| HA | 80 | 80 | 80 | |
| EHA | | | | 80 |
| HBA | 20 | 20 | 20 | 20 |
| HEA | | | | |
| Initiator-1 | 0.03 | 0.03 | 0.03 | 0.03 |
| Initiator-2 | 0.25 | 0.25 | | 0.25 |
| Initiator-3 | | | 0.25 | |
| Silane | 0.1 | | 0.1 | 0.1 |
| UA | 0.1 | 0.1 | 0.1 | 0.1 |

### Comparative Examples C6-C11

Adhesive samples were prepared as described above using the formulations shown in Table 4 below and tested for aging performance. Testing at 85° C. for 7 days for Comparative Examples C5-C11 is shown in Table 2.

TABLE 2
Comparative Adhesive Formulations

| | C5 | C6 | C7 | C8 | C9 | C10 | C11 |
|---|---|---|---|---|---|---|---|
| HA | 90 | 100 | 80 | 80 | 80 | 80 | 70 |
| EHA | | | | | | | |
| HBA | 10 | | 20 | 20 | 20 | | |
| HEA | | | | | | | |
| EHMA | | | | | | | |
| AcM | | | | | | | |
| IBXA | | | | | | 20 | |
| NNDMA | | | | | | | 30 |
| Initiator-1 | 0.03 | 0.03 | 0.03 | 0.03 | 0.03 | 0.03 | 0.03 |
| Initiator-2 | 0.25 | 0.25 | 0.25 | 0.25 | 0.25 | 0.25 | 0.25 |
| Initiator-3 | | | | | | | |
| Silane | 0.1 | 0.1 | 0.1 | 0.1 | 0.1 | 0.1 | 0.1 |
| UA | 0.1 | 0.1 | 0.1 | 0.1 | 0.1 | 0.1 | 0.1 |
| HDDA | | | | | | | |
| AA | | | 0.1 | 0.2 | 0.3 | | |

TABLE 3
Stress Relaxation change after 7 Days at 85° C.

| Example | Initial | After Aging | Difference |
|---|---|---|---|
| C1 | 0.209 | 0.319 | 0.110 |
| C2 | 0.205 | 0.310 | 0.105 |
| C3 | 0.043 | 0.248 | 0.205 |
| C4 | 0.231 | 0.333 | 0.102 |
| C5 | 0.040 | 0.071 | 0.031 |
| C6 | 0.001 | 0.001 | 0.000 |
| C7 | 0.201 | 0.535 | 0.334 |
| C8 | 0.198 | 0.723 | 0.525 |
| C9 | 0.200 | 0.663 | 0.463 |
| C10 | 0.442 | 0.411 | −0.031 |
| C11 | 0.382 | 0.338 | −0.044 |

### Comparative Examples C12-C10

A series of amine compounds, various types of amino acrylate, radical scavenger, hindered amine light stabilizers and triethylamine, were investigated to prevent or retard the esterification reaction between hydroxyl and acid but none of them was effective.

Adhesive samples were prepared as described above using the formulations shown in Table 4 below and tested for aging performance. Testing at 85° C. for 7 days for Comparative Examples C12-C19 is shown in Table 5.

TABLE 4
Comparative Adhesive Formulations

| | C12 | C13 | C14 | C15 | C16 | C17 | C18 | C19 |
|---|---|---|---|---|---|---|---|---|
| HA | 80 | 80 | 80 | 80 | 80 | 80 | 80 | 80 |
| HBA | 20 | 20 | 20 | 20 | 20 | 20 | 20 | 20 |
| Initiator-1 | 0.03 | 0.03 | 0.03 | 0.03 | 0.03 | 0.03 | 0.03 | 0.03 |
| Initiator-2 | 0.25 | 0.25 | 0.25 | 0.25 | 0.25 | 0.25 | 0.25 | 0.25 |
| Silane | 0.1 | 0.1 | 0.1 | 0.1 | 0.1 | 0.1 | 0.1 | 0.1 |
| UA | 0.1 | 0.1 | 0.1 | 0.1 | 0.1 | 0.1 | 0.1 | 0.1 |
| AO | 0.4 | | | | | | | |
| HALS-1 | | 0.5 | | | | | | |
| HALS-2 | | | 0.5 | | | | | |
| TEA | | | | 0.05 | | | | |
| AcM | | | | | 1 | | | |
| DMAEA | | | | | | 2 | | |
| NNDMA | | | | | | | 1 | |
| DMAPMA | | | | | | | | 2 |

TABLE 5
Stress Relaxation change after 7 Days at 85° C.

| Example | Initial | After Aging | Difference |
|---|---|---|---|
| C12 | 0.191 | 0.290 | 0.099 |
| C13 | 0.191 | 0.305 | 0.114 |
| C14 | 0.170 | 0.276 | 0.106 |
| C15 | 0.181 | 0.388 | 0.207 |
| C16 | 0.240 | 0.394 | 0.154 |
| C17 | 0.205 | 0.298 | 0.093 |
| C18 | 0.219 | 0.316 | 0.097 |
| C19 | 0.315 | 0.678 | 0.363 |

TABLE B
High Temperature Stabilization Agents

| Abbreviation | Structure/Feature | Description and Supplier |
|---|---|---|
| HT-1 | Hydrotalcite | Commercially available as DHT-4A |
| | | from Kisuma (JP), described as |
| | | Standard (size 0.5 micrometers) |
| HT-2 | Hydrotalcite | Commercially available as DHT-4C |
| | | from Kisuma (JP), described as |
| | | thermally stable |
| CD-1 | Carbodiimide | Commercially available as LUBIO |
| | biopolymer | ASI from Schaefer Additivsysteme |
| | mixture | (GM), 50% carbodiimide |
| CD-2 | Unknown | Commercially available as LUBIO |
| | | AS14 from Schaefer Additivsysteme |
| | | (GM) |
| CD-3 | Carbodiimide | Commercially available as LUBIO |
| | (Aromatic) | AS10 from Schaefer Additivsysteme |
| | | (GM), 100% carbodiimide |
| CD-4 | Unknown | Commercially available as LUBIO |
| | | V677 from Schaefer Additivsysteme |
| | | (GM) |
| CD-5 | Carbodiimide | Commercially available as CARBO- |
| | (polymer) | DILITE V04F from Nisshinbo (JP) |
| CD-6 | Carbodiimide | Commercially available as CARBO- |
| | (polymer) | DILITE V05 from Nisshinbo (JP), |
| | | described as having 8.3% isocyanate |
| CD-7 | Bis(2,6- | Commercially available from TCI |
| | diisopropylphenyl) | (JP) |
| | carbodiimide | |

### Examples E1-E5 and Comparative Examples C20-C23

Adhesive samples were prepared that include the high temperature stabilizing agents of this disclosure as described above using the formulations shown in Table 6 below and tested for aging performance. Testing at 85° C. for 7 days for Examples E1-E5 and Comparative Examples C20-C23 is shown in Table 7. Values for haze are listed for Examples E1 and E2 where the use of hydrotalcite causes an increase in the haze of the formulation. While haze was not measured for the Examples that did not use hydrotalcite, the samples visually had a low haze apparently unchanged from the base optically clear adhesives and are estimated to have a haze of less than 100.

TABLE 6
Adhesive Formulations With Stabilization Agents

| | E1 | E2 | E3 | E4 | C20 | C21 | C22 | C23 | E5 |
|---|---|---|---|---|---|---|---|---|---|
| HA | 80 | 80 | 80 | 80 | 80 | 80 | 80 | 80 | 80 |
| HBA | 20 | 20 | 20 | 20 | 20 | 20 | 20 | 20 | 20 |
| Initi- | 0.03 | 0.03 | 0.03 | 0.03 | 0.03 | 0.03 | 0.03 | 0.03 | 0.03 |
| ator-1 | | | | | | | | | |
| Initi- | 0.25 | 0.25 | 0.25 | 0.25 | 0.25 | 0.25 | 0.25 | 0.25 | 0.25 |
| ator-2 | | | | | | | | | |
| Silane | 0.1 | 0.1 | 0.1 | 0.1 | 0.1 | 0.1 | 0.1 | 0.1 | 0.1 |
| UA | 0.5 | 0.5 | 0.1 | 0.1 | 0.1 | 0.1 | 0.1 | 0.1 | 0.1 |
| HT-1 | 1 | | | | | | | | |
| HT-2 | | 1 | | | | | | | |
| CD-1 | | | 1 | | | | | | |
| CD-2 | | | | 1 | | | | | |
| CD-3 | | | | | 1 | | | | |
| CD-4 | | | | | | 1 | | | |
| CD-5 | | | | | | | 1 | | |
| CD-6 | | | | | | | | 1 | |
| CD-7 | | | | | | | | | 1 |
| Haze | 9.84 | 10.63 | NM | NM | NM | NM | NM | NM | NM |

NM = not measured

TABLE 7
Stress Relaxation change after 7 Days at 85° C.

| Example | Initial | After Aging | Difference |
|---|---|---|---|
| E1 | 0.430 | 0.540 | 0.110 |
| E2 | 0.440 | 0.490 | 0.050 |
| E3 | 0.211 | 0.265 | 0.054 |
| E4 | 0.223 | 0.255 | 0.032 |
| C20 | 0.206 | 0.317 | 0.111 |
| C21 | 0.223 | 0.347 | 0.124 |
| C22 | 0.199 | 0.294 | 0.169 |
| C23 | 0.233 | 0.844 | 0.611 |
| E5 | 0.213 | 0.258 | 0.045 |

What is claimed is:

1. A pressure sensitive adhesive composition comprising:
a (meth)acrylate polymeric or copolymeric matrix, the (meth)acrylate polymeric or copolymeric matrix comprising the reaction product of at least one (meth)acrylate monomer comprising at least one hydroxyl group; and
at least one high temperature stabilization agent, wherein the pressure sensitive adhesive composition is optically transparent and upon exposure to a temperature of at
least 85° C. for 7 days, the increase of cohesive strength as measured by stress relaxation is 0.1 or less.

2. The pressure sensitive adhesive composition of claim 1, wherein the (meth)acrylate polymeric or copolymeric matrix comprises a copolymeric matrix that is the reaction product of a (meth)acrylate monomer of Formula 1:
H₂C═CR¹—(CO)—O—(CH₂)ₐ—OH
wherein R¹ is an H or a methyl group;
(CO) is a carbonyl group C═O; and
a is an integer from 1-5.

3. The pressure sensitive adhesive composition of claim 1, wherein the (meth)acrylate polymeric or copolymeric matrix comprises a copolymeric matrix that is the reaction product of a (meth)acrylate monomer of Formula 1:
H₂C═CR¹—(CO)—O—(CH₂)ₐ—OH
wherein R¹ is an H or a methyl group;
(CO) is a carbonyl group C═O; and
a is an integer from 1-5; and
at least one additional (meth)acrylate monomer of Formula 2:
H₂C═CHR¹—(CO)—O—R² Formula 2
wherein R¹ is a hydrogen atom or a methyl group;
(CO) is a carbonyl group C═O; and
R² is a hydrogen atom, an alkyl group with 4-20 carbon atoms, or an aryl group.

4. The pressure sensitive adhesive composition of claim 1, wherein the at least one high temperature stabilization agent comprises a hydrotalcite, or a carbodiimide.

5. The pressure sensitive adhesive composition of claim 4, wherein the at least one high temperature stabilization agent comprises a hydrotalcite.

6. The pressure sensitive adhesive composition of claim 4, wherein the at least one high temperature stabilization agent comprises a carbodiimide.

7. The pressure sensitive adhesive composition of claim 6, wherein the adhesive composition is optically clear.

8. The pressure sensitive adhesive composition of claim 6, wherein the at least one high temperature stabilization agent comprises bis(2,6-diisopropylphenyl) carbodiimide.

9. The pressure sensitive adhesive composition of claim 1, wherein the at least one high temperature stabilization agent is present in the adhesive composition in an amount of 0.1-5% by weight.

10. An adhesive article comprising”
a substrate comprising a first major surface and a second major surface; and
an adhesive layer disposed on at least a portion of the second major surface of the substrate, wherein the adhesive layer comprises:
a (meth)acrylate polymeric or copolymeric matrix, the (meth)acrylate polymeric or copolymeric matrix comprising the reaction product of at least one (meth)acrylate monomer comprising at least one hydroxyl group; and
at least one high temperature stabilization agent, wherein the pressure sensitive
adhesive composition is optically transparent and upon exposure to a temperature of at least 85° C. for 7 days, the increase of cohesive strength as measured by stress relaxation is 0.1 or less.

11. The article of claim 10, wherein the (meth)acrylate polymeric or copolymeric matrix comprises a copolymeric matrix that is the reaction product of a (meth)acrylate monomer of Formula 1:
H₂C═CR¹—(CO)—O—(CH₂)ₐ—OH
wherein R¹ is an H or a methyl group;
(CO) is a carbonyl group C═O; and
a is an integer from 1-5.

12. The article of claim 10, wherein the (meth)acrylate polymeric or copolymeric matrix comprises a copolymeric matrix that is the reaction product of a (meth)acrylate monomer of Formula 1:
H₂C═CR¹—(CO)—O—(CH₂)ₐ—OH
wherein R¹ is an H or a methyl group;
(CO) is a carbonyl group C═O; and
a is an integer from 1-5; and
at least one additional (meth)acrylate monomer of Formula 2:
H₂C═CHR¹—(CO)—O—R² Formula 2
wherein R¹ is a hydrogen atom or a methyl group;
(CO) is a carbonyl group C═O; and
R² is a hydrogen atom, an alkyl group with 4-20 carbon atoms, or an aryl group.

13. The article of claim 10, wherein the at least one high temperature stabilization agent comprises a hydrotalcite, or a carbodiimide.

14. The article of claim 13, wherein the at least one high temperature stabilization agent comprises a hydrotalcite.

15. The article of claim 13, wherein the at least one high temperature stabilization agent comprises a carbodiimide.

16. The article of claim 15, wherein the adhesive composition is optically clear.

17. The article of claim 15, wherein the at least one high temperature stabilization agent comprises bis(2,6-diisopropylphenyl) carbodiimide.

18. The article of claim 10, wherein the at least one high temperature stabilization agent is present in the adhesive composition in an amount of 0.1-5% by weight.

19. The article of claim 10, wherein the substrate comprises a polymeric film or a release liner.

20. The article of claim 19, wherein the polymeric film comprises an optical film.
